(19) United States
(12) Patent Application Publication
(10) Pub. No.: US 2009/0294311 A1
(43) Pub. Date: Dec. 3, 2009

(54) GARMENT PACKAGE

(75) Inventor: Christopher T. Caldwell, Lenoir, NC (US)

Correspondence Address: Avery Dennison Corporation, 170 MONARCH LANE, MIAMISBURG, OH, 45342, US

(73) Assignee: AVERY DENNISON CORPORATION, Pasadena, CA (US)

(21) Appl. No.: 12/129,129

(22) Filed: May 29, 2008

(51) Int. Cl. B65D 85/18; G09F 3/18; G09F 3/14

(52) U.S. Cl. 206/281; 206/292; 206/278; 40/661.04; 40/665

(57) ABSTRACT

There is disclosed a garment package and method of making a garment package. A band keeps a garment in a folded condition in spite of handling by manufacturing and retailing personnel and potential customers.

### BACKGROUND

Field

This invention relates to garment packages and method of making garment packages.

### BRIEF DESCRIPTION OF THE PRIOR ART

The following U.S. Patents are made of record: U.S. Pat. No. D505,064; U.S. Pat. No. D533,774; U.S. Pat. No. 4,476,173; U.S. Pat. No. 4,512,096; U.S. Pat. No. 4,822,448; U.S. Pat. No. 5,390,434; U.S. Pat. 5,704,144; U.S. Pat. No. 5,775,019; U.S. Pat. No. 5,878,520; U.S. Pat. 5,970,641; U.S. Pat. No. 6,279,255; U.S. Pat. No. 6,915,602; WO 0153586; and EP 1652501.

### SUMMARY

The disclosed embodiment relates to an improved garment package in which a garment such as a pair of boxer shorts can be held in a folded configuration for handling and display purposes. The folded garment has planar or generally flat opposed sides. The package preferably includes a garment, preferably held slightly gathered by a non-stretchable band located between ends of the folded garment. The band can be comprised of a strip of material having marginal end portions which have been attached to form an endless band. The attached marginal end portions can project into space within the band and into contact with the garment. There are indicia on the outside of the band. The band is preferably comprised of a material with transverse ridges at least at the inner side of the band. The ridges and the attached marginal end portions tend to keep the band from shifting or translating with respect to the garment so that the indicia remain correctly oriented or registered with respect to the side of the garment.

According to a specific embodiment of a method, there are steps of providing a flexible strip having a first side and an opposite second side with indicia on the second side, the strip having marginal end portions, bringing the marginal and portions together at the second sides, attaching the marginal end portions to each other to form an endless band with the attached marginal end portions projecting outwardly, turning the band inside out, and slipping the band onto the garment. It is preferred that the band be sized relative to the size of the folded garment to hold the folded garment slightly gathered. When the band is slipped onto the garment indicia related to garment parameters are oriented with respect to a side of the garment.

### BRIEF DESCRIPTION OF THE DIAGRAMMATIC DRAWINGS

FIG. 1 is a top plan view of a folded garment with a band around the folded garment;

FIG. 2 is a top plan view of a strip of flexible material used to form an endless band that can pass around the folded garment;

FIG. 3 is a sectional view taken along line 3-3 of FIG. 2;

FIG. 4 is a pictorial view of the band illustrating that the strip has been formed into a loop with opposed marginal ends having been brought into face-to-face relationship and sealed to each other;

FIG. 5 is a pictorial view of the endless band of FIG. 4 turned inside out;

FIG. 6 is a sectional view taken generally along line 6-6 of FIG. 1; and

FIG. 7 is an enlarged fragmentary view of the band and the garment with the attached marginal end portions in frictional contact with the garment.

### PREFERRED EMBODIMENTS

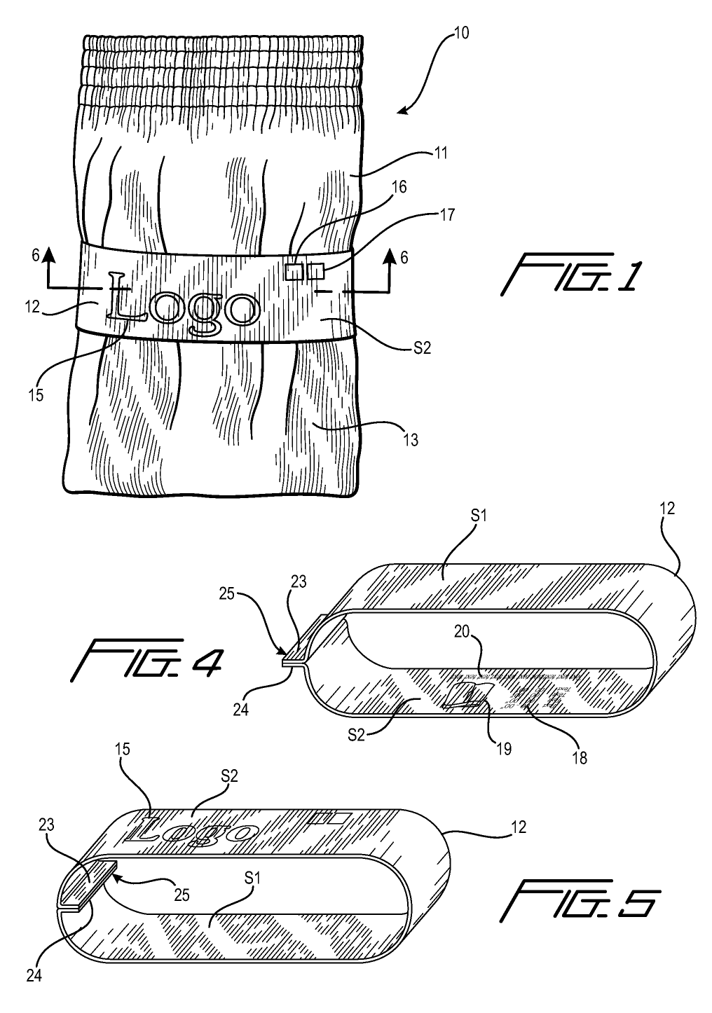

With reference to FIGS. 1 and 2, there is shown a garment package generally indicated at 10 including a garment 11 and an endless band 12. The garment 11 can be an article of wearing apparel such as a pair of boxer shorts as shown. The garment 11 has been folded into a generally rectangular shape. The band 12 holds the garment in its folded condition. The band 12 is preferably sized relative to the garment 11 to be small enough in extent so as to gather the folded garment slightly to help prevent the band 12 from shifting during handling of the package 10. The package 10 has a front side 13 and a rear side 14. The band 12 has a side S1 and an opposite side S2. The side 52 carries indicia 15 for example a logo and areas 16 and 17 that can carry for example quantity and size information, respectively. The side S2 can also carry various indicia 18, 19 and 20 including washing instructions. Indicia 15 through 17 are aligned or registered with the front side 13 of the garment 11 and indicia 18 through 20 are aligned or registered with the rear side 14 of the garment 11. The indicia 15 through 20 can be printed or otherwise suitably applied to side S2 depicted in FIG. 2 for example. The indicia 15 through 20 are preferably in a contrasting color from that of the band 12.

FIG. 2 shows a strip or elongate sheet S prior to being formed into the band 12. The strip S can be comprised of a flexible material such as a woven fabric which is preferably non-stretchable. Any suitable fabric may be used such as polyester. The indicia 15 through 20 are printed on the second side S2 and side S1 is preferably free of indicia. Side S1 preferably has transverse ridges 21 and side S2 can also have transverse ridges 22 characteristic of the fabric. The transverse ridges 21 and 22 are preferably equally and closely spaced throughout the longitudinal extent of the strip S as best shown in FIG. 3.

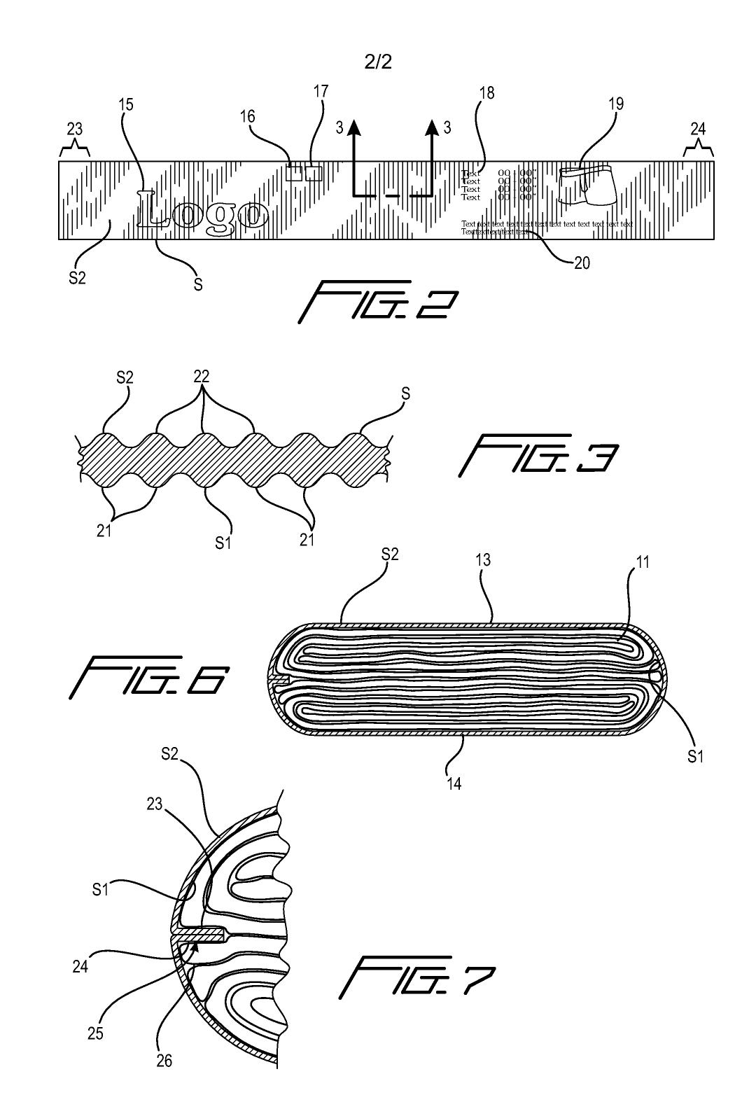

In making the band 12 from the strip S, opposite marginal end portions 23 and 24 of side S2 of the strip S are placed in face-to-face relationship as shown in FIG. 4. Thereupon, the marginal end portions 23 and 24 are suitably attached to each other to complete the formation of the strip S into the band 12. The attachment of the marginal end portions 23 and 24 to each other can be by any suitable method such as ultrasonic welding. The ridges 22 assist in making the ultrasonic web. Other methods such as adhesive especially a heat-activatable adhesive may also be used alternatively, particularly with fabrics that do not readily weld or fuse. The band 12 is now permanently formed into a closed loop with the printing on the inside surface of the band 12. The lapped marginal end portions form a projection 25. Thereafter, the band 12 is turned inside out so that the indicia 15 through 20 are on the outside. Next the band 12 is slipped onto the garment 11 to the position shown in FIG. 1.

The ridges 21 on side S1 frictionally contact the garment 11 and help prevent the band from shifting around the garment 11 so that the indicia 15 through 17 and 18 through 20 are respectively held registered with the front side 12 and the rear side 13 of the garment 11.

The projection 25 also contacts the garment 11 at an end 26 and helps to keep the band 12 from shifting out of registration around the garment 11.

Other embodiments and modifications of the invention will suggest themselves to those skilled in the art, and all such of these as come within the spirit of this invention are included within its scope as best defined by the appended claims.

I claim:

1. A garment package, comprising:
a garment having opposite generally planar, sides and opposite ends,
a strip composed of a non-stretchable material and having opposite marginal end portions, the marginal end portions being attached to form an endless band, the attached marginal end portions projecting into space within the band and into contact the garment, the endless band being of a size to grip the garment and hold the garment gathered, the band having an outer surface, and indicia on the outer surface at least one side of the garment.

2. A garment package as defined in claim 1, wherein the band has transverse ridges on at least the inner surface of the band.

3. A garment package as defined in claim 1, wherein the band has transverse ridges at its inner and outer surfaces.

4. Method of making a garment package, comprising:
providing a flexible strip having marginal end portions,
bringing the marginal end portions together,
attaching the marginal end portions to each other to form an endless band with the attached marginal end portions projecting outwardly,
turning the band inside out, and
slipping the band onto the garment.

5. Method as defined in claim 4, wherein the band is sized relative to the size of the folded garment to hold the folded garment slightly gathered.

6. Method as defined in claim 4, wherein the outside of the band has indicia, and orienting the indicia with respect to the garment.
